(19) United States
(12) Patent Application Publication
(10) Pub. No.: US 2016/0196542 A1
(43) Pub. Date: Jul. 7, 2016

(54) Providing Enhanced Online Bill Pay User Interfaces

(71) Applicant: BANK OF AMERICA CORPORATION, Charlotte, NC (US)

(72) Inventor: Vignesh Chandrasekaran, Chennai (IN)

(21) Appl. No.: 14/590,316

(22) Filed: Jan. 6, 2015

(51) Int. Cl. G06Q 20/14; G06F 3/0484; G06Q 30/04

(52) U.S. Cl. CPC G06Q 20/14; G06Q 30/04; G06F 3/0484

(57) ABSTRACT

Methods, systems, and computer-readable media for providing enhanced user interfaces are presented. In one or more embodiments, a computing platform may receive, from a customer computing device, a request for an online bill pay page. Subsequently, the computing platform may generate, based on the request for the online bill pay page, an online bill pay user interface. The computing platform then may send, to the customer computing device, the online bill pay user interface. Thereafter, the computing platform may receive, from the customer computing device, a call-back request corresponding to a bill that was issued by a third-party entity. Subsequently, the computing platform may establish a connection to a third-party server of the third-party entity that issued the bill included in the online bill pay user interface. The computing platform then may cause the third-party server to initiate a call to the user of the customer computing device.

### BACKGROUND

Aspects of the disclosure relate to computer hardware and software. In particular, one or more aspects of the disclosure generally relate to computer hardware and software for providing enhanced user interfaces, such as online bill pay user interfaces which may be provided in connection with an online banking portal.

Large organizations, such as financial institutions, may serve many customers, and increasingly, customers of such organizations are using computing devices, including mobile computing devices, to interact with the organizations about the products and/or services offered by these organizations. Some large organizations may even provide specialized websites and/or customer portals for their customers that allow customers to view and/or purchase various products and/or services online, conduct transactions, and view and/or manage one or more accounts.

These websites and customer portals are becoming increasingly popular, and customers of various organizations continue to demand greater functionality via such portals, as well as increasingly easy-to-use and convenient ways of utilizing such functionality.

### SUMMARY

Aspects of the disclosure relate to various systems and techniques that provide effective, efficient, scalable, and convenient ways of providing customer portals and other specialized websites, particularly in ways that enhance the functionality of online bill pay user interfaces which may be provided in connection with an online banking portal and which may enable a customer of a financial institution to pay one or more bills that may be electronically received by the financial institution on behalf of the customer.

For example, some aspects of the disclosure provide ways for a customer of a financial institution to receive electronic bills from third-party entities within an online bill pay user interface and subsequently contact one or more of the third-party entities using functionality provided by the online bill pay user interface. For example, the online bill pay user interface may include one or more buttons and/or other controls that allow a user (who may, e.g., be a customer of the financial institution) to request a call-back communication from a third-party entity that issued a particular bill presented in the online bill pay user interface. In some instances, the call-back communication may be an automatically initiated telephone call. In other instances, the call-back communication may be an email communication, text message communication, or other form of communication. In one or more arrangements, the customer's authentication status within the online bill pay user interface may be passed to the third-party entity along with the call-back request so that the third-party entity does not have to re-authenticate the customer, thus increasing convenience to the customer. In addition, other account details and customer information may be passed to the third-party entity along with the callback request, so that the customer does not have to provide such information to a customer service representative of the third-party entity, thereby creating a seamless experience for the customer and further increasing convenience to the customer.

In accordance with one or more embodiments, an online banking computing platform having at least one processor, a memory, and a communication interface may receive, via the communication interface, and from a customer computing device, a request for an online bill pay page for a user of the customer computing device. Subsequently, the online banking computing platform may generate, based on the request for the online bill pay page, an online bill pay user interface for the user of the customer computing device. The online banking computing platform then may send, via the communication interface, and to the customer computing device, the online bill pay user interface. Thereafter, the online banking computing platform may receive, via the communication interface, and from the customer computing device, a call-back request corresponding to a bill that was issued by a third-party entity and that is included in the online bill pay user interface. Subsequently, the online banking computing platform may establish, via the communication interface, a connection to a third-party server of the third-party entity that issued the bill included in the online bill pay user interface. The online banking computing platform then may cause the third-party server to initiate a call to the user of the customer computing device.

In some embodiments, causing the third-party server to initiate the call to the user of the customer computing device may include sending customer information for the user of the customer computing device to the third-party server. In some instances, the customer information may include an account number of the user of the customer computing device that is assigned to the user of the customer computing device by the third-party entity. Additionally or alternatively, the customer information may include a name of the user of the customer computing device and contact information for the user of the customer computing device. Such contact information may, for example, include a phone number of the customer, an email address of the customer, and/or a call-back phone number of the customer.

In some instances, the customer information for the user of the customer computing device may be presented to a customer service representative of the third-party entity.

In some embodiments, after causing the third-party server to initiate the call to the user of the customer computing device, the online banking computing platform may generate a notification indicating that the call-back request has been submitted to the third-party entity.

Subsequently, the online banking computing platform may send, via the communication interface, and to the customer computing device, the notification indicating that the call-back request has been submitted to the third-party entity. In some instances, the notification indicating that the call-back request has been submitted to the third-party entity may include information indicating an expected call-back time determined based on current call volume information.

In some embodiments, the online banking computing platform may be configured to present at least one notification generated by the third-party entity in the online bill pay user interface. In some instances, such a notification may be presented to all customers of the financial institution who receive electronic bills from the third-party entity, while in other instances, such a notification may be presented to selected customers who receive electronic bills from the third-party entity based on account information that may be registered with the financial institution, such as information indicative of the customers' state of residence.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an illustrative operating environment in which various aspects of the disclosure may be implemented in accordance with one or more example embodiments;

FIG. 2 depicts an illustrative block diagram of workstations and servers that may be used to implement the processes and functions of certain aspects of the present disclosure in accordance with one or more example embodiments;

FIG. 3 depicts an illustrative computing environment for providing enhanced online bill pay user interfaces in accordance with one or more example embodiments;

FIGS. 4A-4I depict an illustrative event sequence for providing enhanced online bill pay user interfaces in accordance with one or more example embodiments;

FIGS. 5-8 depict example graphical user interfaces for providing enhanced online bill pay user interfaces in accordance with one or more example embodiments; and

FIG. 9 depicts an illustrative method for providing enhanced online bill pay user interfaces in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

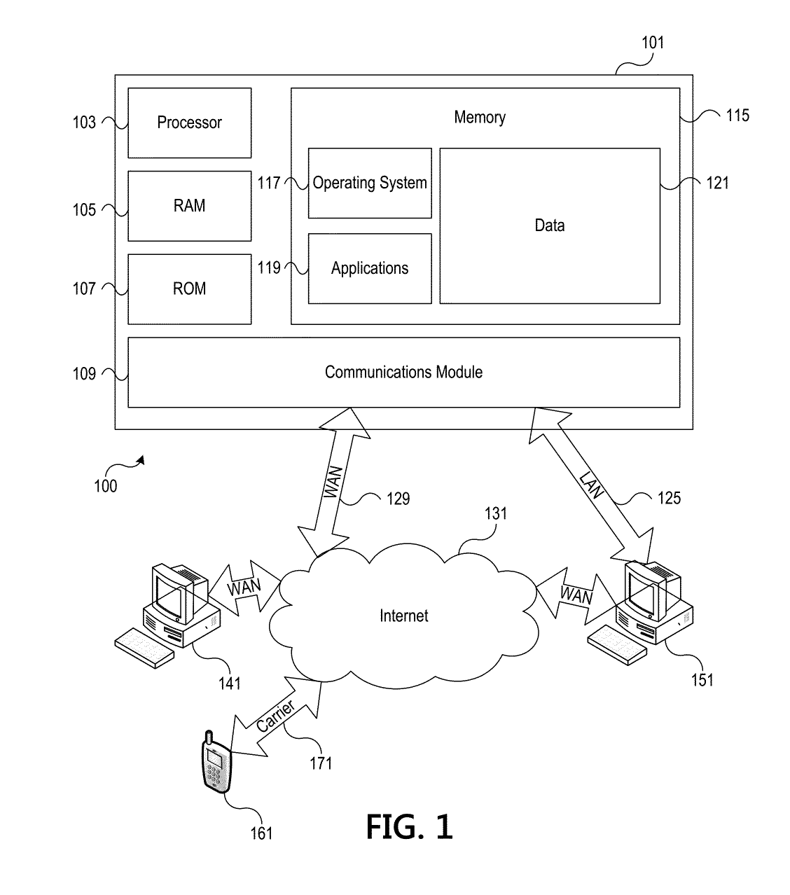

FIG. 1 depicts an illustrative operating environment in which various aspects of the present disclosure may be implemented in accordance with one or more example embodiments. Referring to FIG. 1, computing system environment 100 may be used according to one or more illustrative embodiments. Computing system environment 100 is only one example of a suitable computing environment and is not intended to suggest any limitation as to the scope of use or functionality contained in the disclosure. Computing system environment 100 should not be interpreted as having any dependency or requirement relating to any one or combination of components shown in illustrative computing system environment 100.

Computing system environment 100 may include computing device 101 having processor 103 for controlling overall operation of computing device 101 and its associated components, including random-access memory (RAM) 105, read-only memory (ROM) 107, communications module 109, and memory 115. Computing device 101 may include a variety of computer readable media. Computer readable media may be any available media that may be accessed by computing device 101, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium that can be used to store the desired information and that can be accessed by computing device 101.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor on computing device 101. Such a processor may execute computer-executable instructions stored on a computer-readable medium.

Software may be stored within memory 115 and/or storage to provide instructions to processor 103 for enabling computing device 101 to perform various functions. For example, memory 115 may store software used by computing device 101, such as operating system 117, application programs 119, and associated database 121. Also, some or all of the computer executable instructions for computing device 101 may be embodied in hardware or firmware. Although not shown, RAM 105 may include one or more applications representing the application data stored in RAM 105 while computing device 101 is on and corresponding software applications (e.g., software tasks) are running on computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output. Computing system environment 100 may also include optical scanners (not shown). Exemplary usages include scanning and converting paper documents, e.g., correspondence, receipts, and the like, to digital files.

Computing device 101 may operate in a networked environment supporting connections to one or more remote computing devices, such as computing devices 141, 151, and 161. Computing devices 141, 151, and 161 may be personal computing devices or servers that include any or all of the elements described above relative to computing device 101. Computing device 161 may be a mobile device (e.g., smart phone) communicating over wireless carrier channel 171.

The network connections depicted in FIG. 1 may include local area network (LAN) 125 and wide area network (WAN) 129, as well as other networks. When used in a LAN networking environment, computing device 101 may be connected to LAN 125 through a network interface or adapter in communications module 109. When used in a WAN networking environment, computing device 101 may include a modem in communications module 109 or other means for establishing communications over WAN 129, such as Internet 131 or other type of computer network. The network connections shown are illustrative and other means of establishing a communications link between the computing devices may be used. Various well-known protocols such as transmission control protocol/Internet protocol (TCP/IP), Ethernet, file transfer protocol (FTP), hypertext transfer protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like.

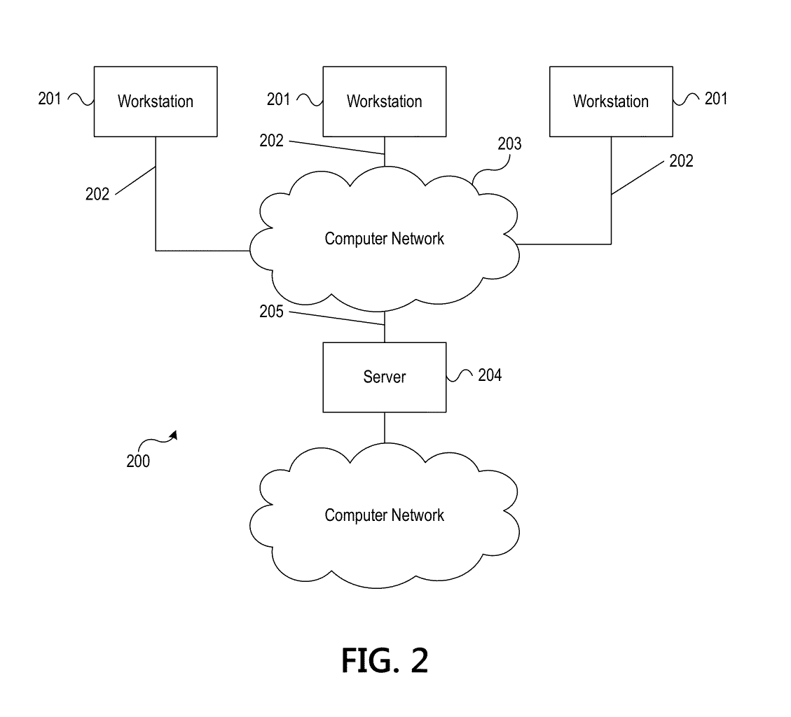

FIG. 2 depicts an illustrative block diagram of workstations and servers that may be used to implement the processes and functions of certain aspects of the present disclosure in accordance with one or more example embodiments. Referring to FIG. 2, illustrative system 200 may be used for implementing example embodiments according to the present disclosure. As illustrated, system 200 may include one or more workstation computers 201. Workstation 201 may be, for example, a desktop computer, a smartphone, a wireless device, a tablet computer, a laptop computer, and the like. Workstations 201 may be local or remote, and may be connected by one of communications links 202 to computer network 203 that is linked via communications link 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, as well as network types developed in the future, and the like.

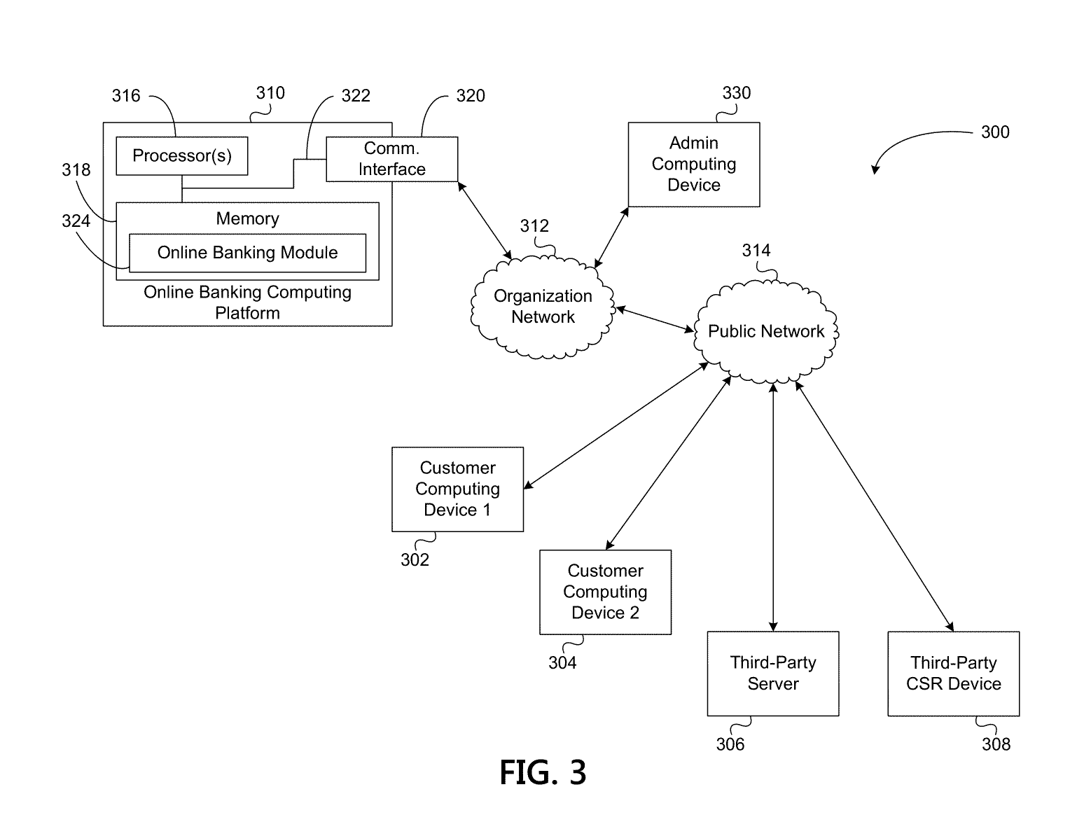

FIG. 3 depicts an illustrative computing environment for providing enhanced online bill pay user interfaces in accordance with one or more example embodiments. Referring to FIG. 3, computing environment 300 may include one or more computing devices. For example, computing environment 300 may include a first customer computing device 302 (which may, e.g., be used by a first customer of an organization, such as a financial institution. Computing environment 300 also may include a second customer computing device 304 (which may, e.g., be used by a second customer of the organization different from the first customer of the organization).

Computing environment 300 also may include third-party server 306, which may be a computer server that includes one or more computing devices and which may, for example, be used by, operated by, maintained by, and/or otherwise associated with a third-party entity different from the organization and the customers of the organization (who may, e.g., use customer computing device 302 and customer computing device 304). Third-party server 306 may, for instance, be used by a third-party entity (e.g., an electric company, a phone company, a gas company, or the like) in generating and processing bills for various customers of the third-party entity. In addition, third-party server 306 may communicate with one or more servers and/or other computing devices that are used by and/or otherwise associated with a financial institution to enable bills generated by the third-party entity to be presented to customers of the financial institution on one or more online bill pay pages that may be provided in connection with an online banking portal, as discussed in greater detail below. Computing environment 300 also may include third-party customer service representative computing device 308 (which may, e.g., be used by a customer service representative of the third-party entity who may handle calls from customers of the third-party entity about bills and other inquiries, as discussed in greater detail below).

Computing environment 300 also may include an administrative computing device 330 (which may, e.g., be used by and/or operated by an administrative user or other individual who may be associated with the organization and who may administer and/or otherwise control various computing devices and/or computer systems that are operated by and/or otherwise associated with the organization).

Customer computing device 302, customer computing device 304, third-party server 306, third-party customer service representative computing device 308, and administrative computing device 330 may be any type of computing device capable of receiving a user interface, receiving input via the user interface, and communicating the received input to one or more other computing devices. For example, customer computing device 302, customer computing device 304, third-party server 306, third-party customer service representative computing device 308, and administrative computing device 330 may be a desktop computer, laptop computer, tablet computer, smart phone, or the like.

Computing environment 300 also may include one or more computing platforms. For example, computing environment 300 may include online banking computing platform 310. Online banking computing platform 310 may include one or more computing devices configured to perform one or more of the functions described herein. For example, online banking computing platform 310 may include one or more computers (e.g., laptop computers, desktop computers, servers, server blades, or the like).

Computing environment 300 also may include one or more networks, which may interconnect one or more of customer computing device 302, customer computing device 304, third-party server 306, third-party customer service representative computing device 308, and online banking computing platform 310. For example, computing environment 300 may include organization network 312 and public network 314. Organization network 312 and/or public network 314 may include one or more sub-networks (e.g., LANs, WANs, or the like). Organization network 312 may be associated with a particular organization (e.g., a corporation, financial institution, educational institution, governmental institution, or the like) and may interconnect one or more computing devices associated with the organization. For example, administrative computing device 330 and online banking computing platform 310 may be associated with an organization (e.g., a financial institution), and organization network 312 may be associated with and/or operated by the organization, and may include one or more networks (e.g., LANs, WANs, VPNs, or the like) that interconnect administrative computing device 330 and online banking computing platform 310 and one or more other computing devices and/or computer systems that are used by, operated by, and/or otherwise associated with the organization. Public network 314 may connect organization network 312 and/or one or more computing devices connected thereto (e.g., administrative computing device 330 and online banking computing platform 310) with one or more networks and/or computing devices that are not associated with the organization. For example, customer computing device 302, customer computing device 304, third-party server 306, and third-party customer service representative computing device 308 might not be associated with an organization that operates organization network 312, and public network 314 may include one or more networks (e.g., the Internet) that connect customer computing device 302, customer computing device 304, third-party server 306, and third-party customer service representative computing device 308 to organization network 312 and/or one or more computing devices connected thereto (e.g., administrative computing device 330 and online banking computing platform 310).

Online banking computing platform 310 may include one or more processor(s) 316, memory 318, communication interface 320, and data bus 322. Data bus 322 may interconnect processor(s) 316, memory 318, and/or communication interface 320. Communication interface 320 may be a network interface configured to support communication between online banking computing platform 310 and organization network 312, or one or more sub-networks thereof. Memory 318 may include one or more program modules comprising instructions that when executed by the processor(s) 316 cause online banking computing platform 310 to perform one or more functions described herein. For example, memory 318 may include online banking module 324, which may comprise instructions that when executed by processor(s) 316 cause online banking computing platform 310 to perform one or more functions described herein.

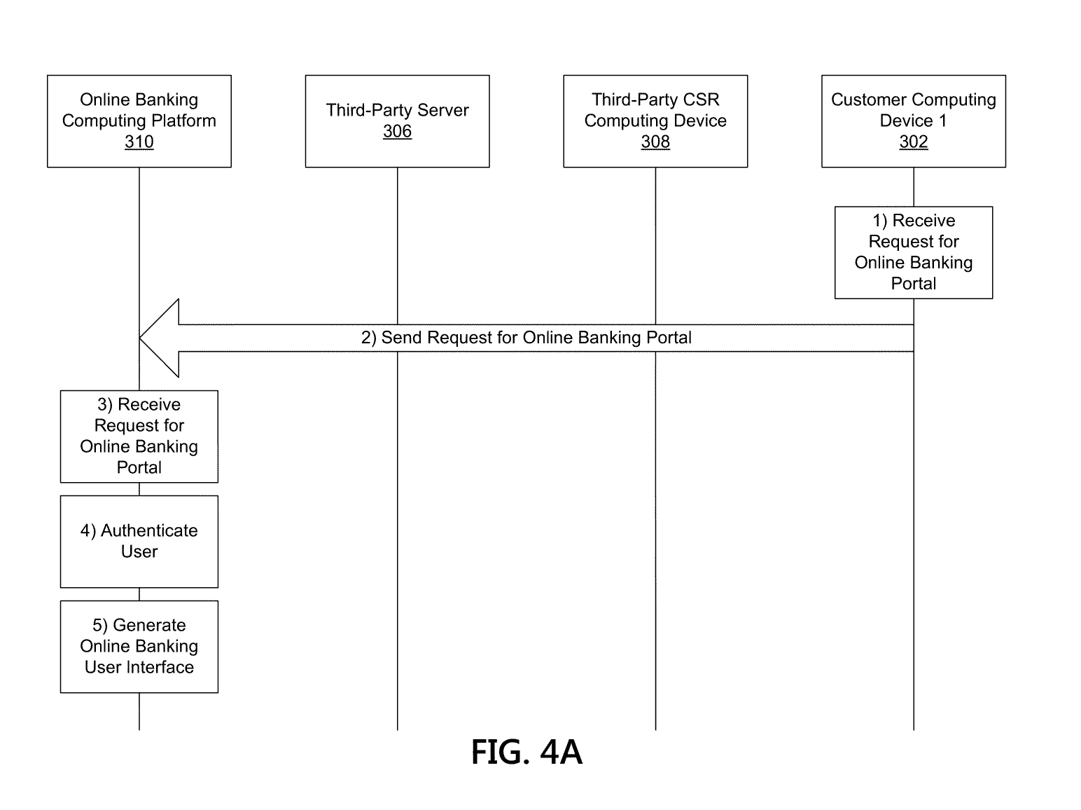

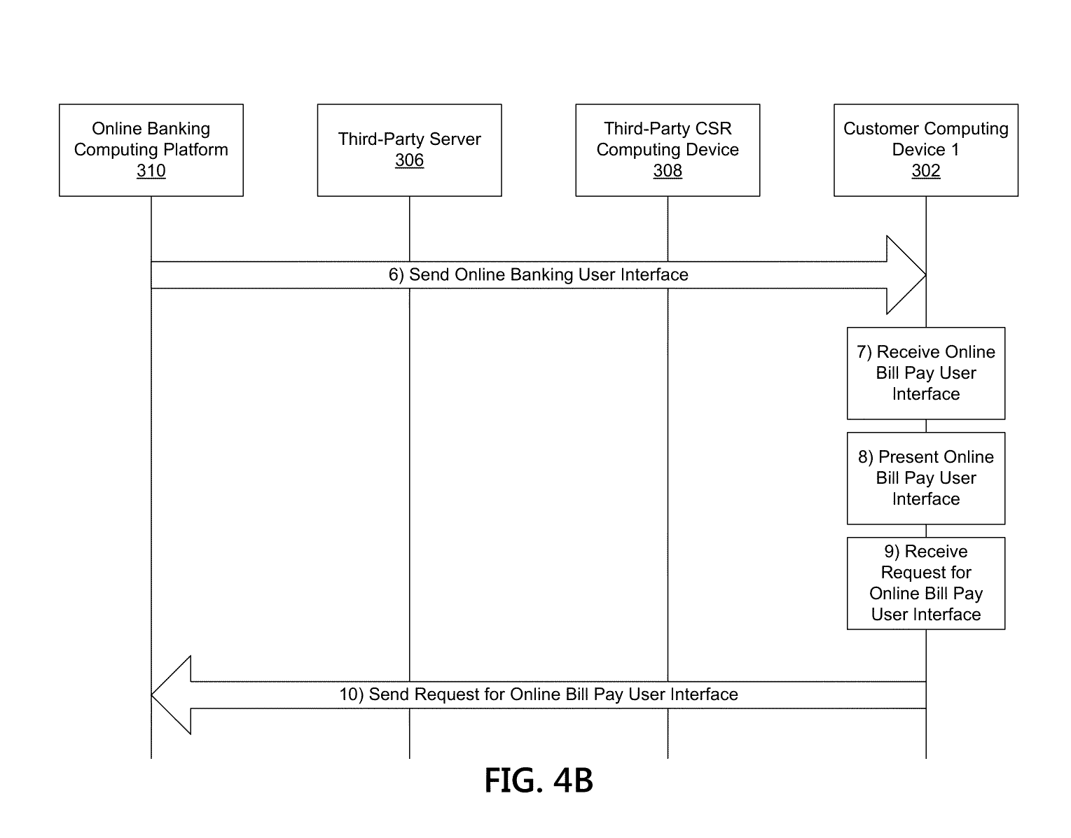

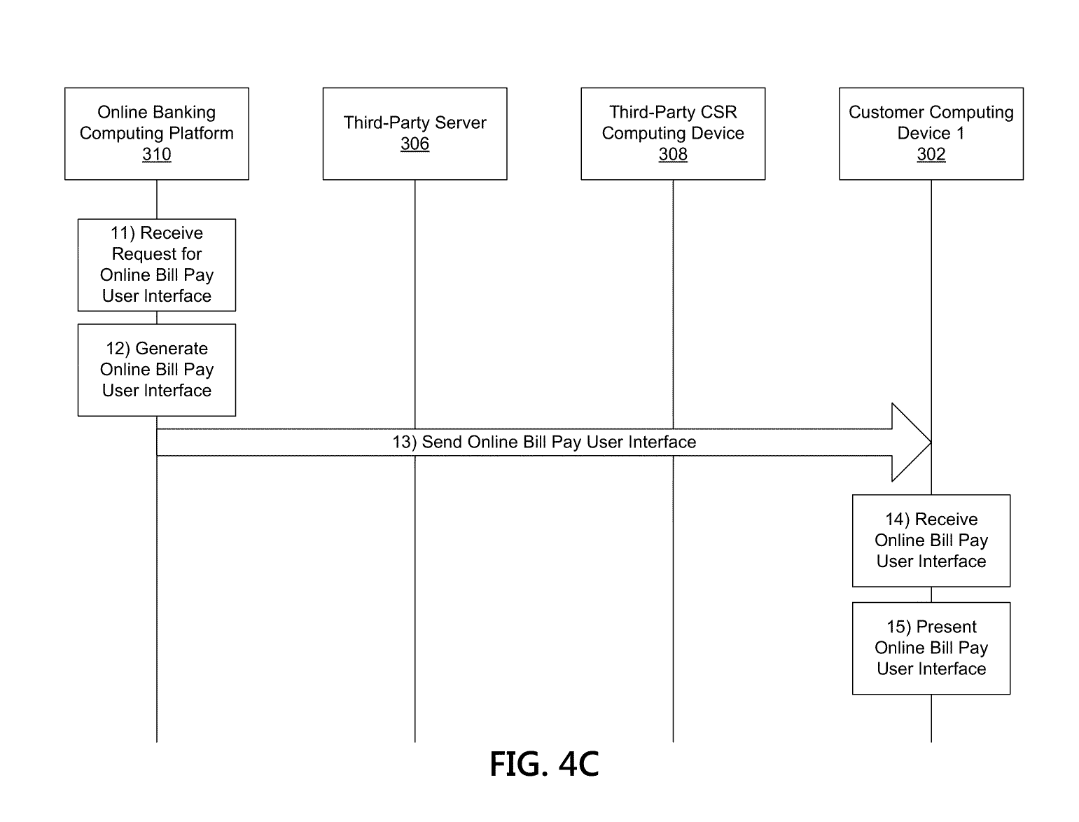

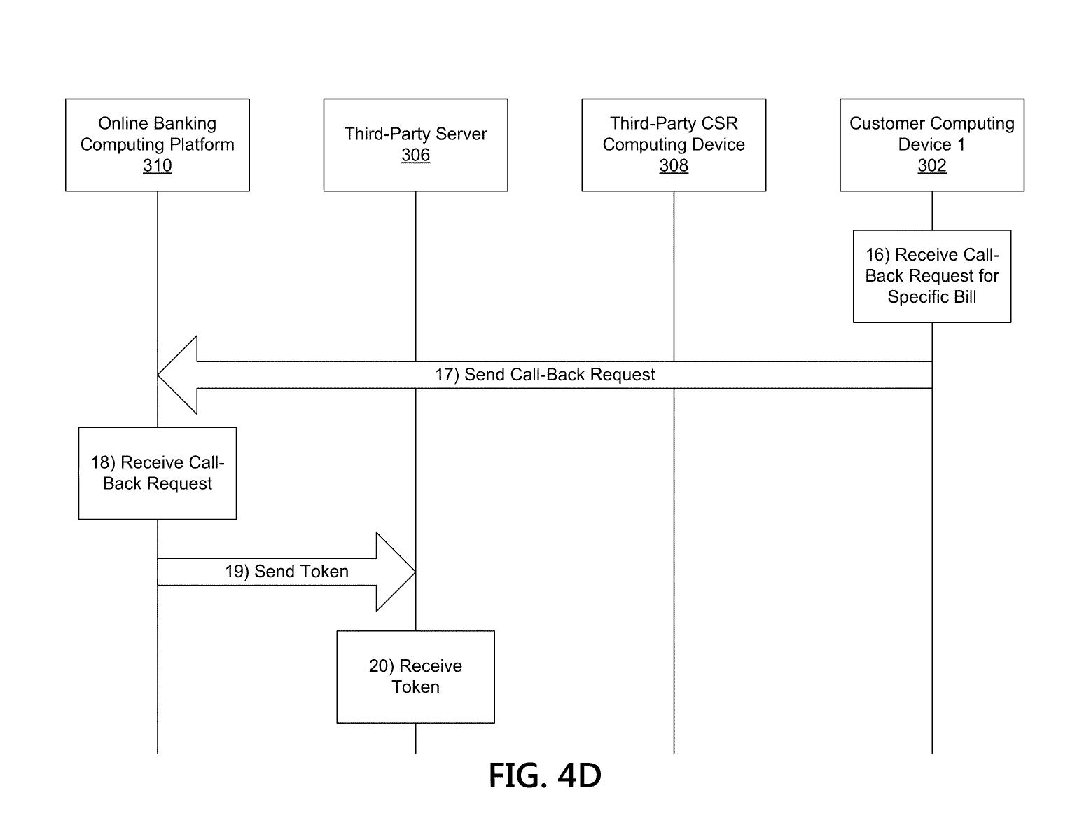

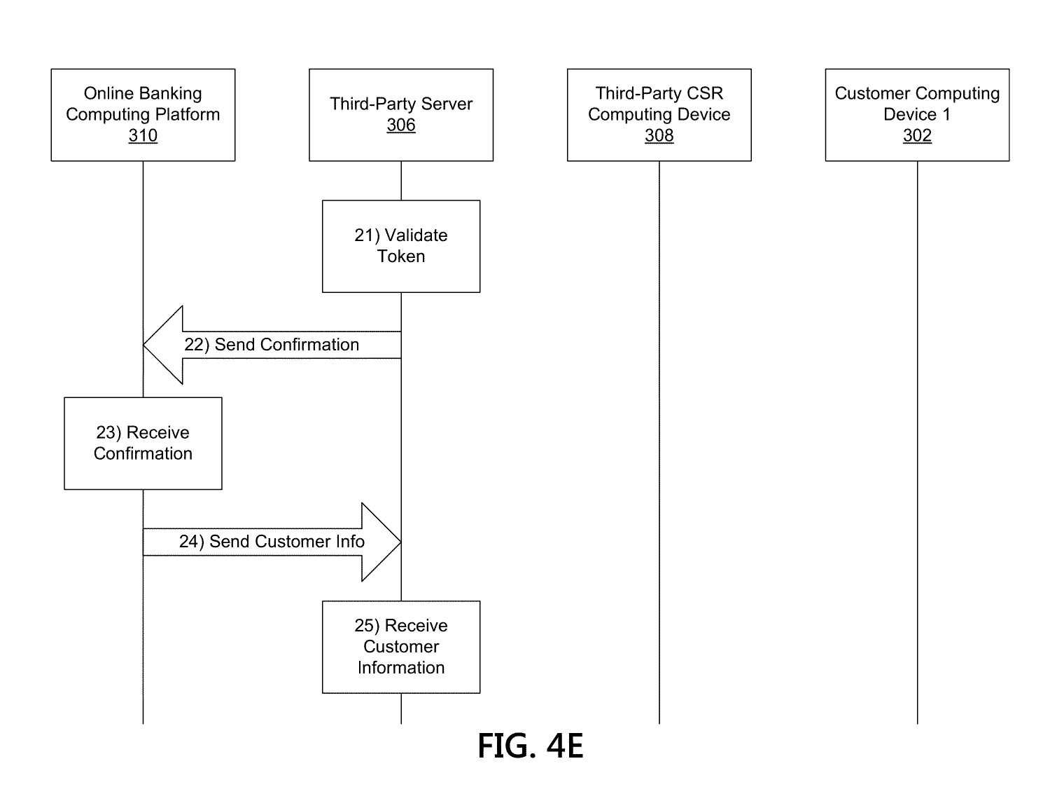

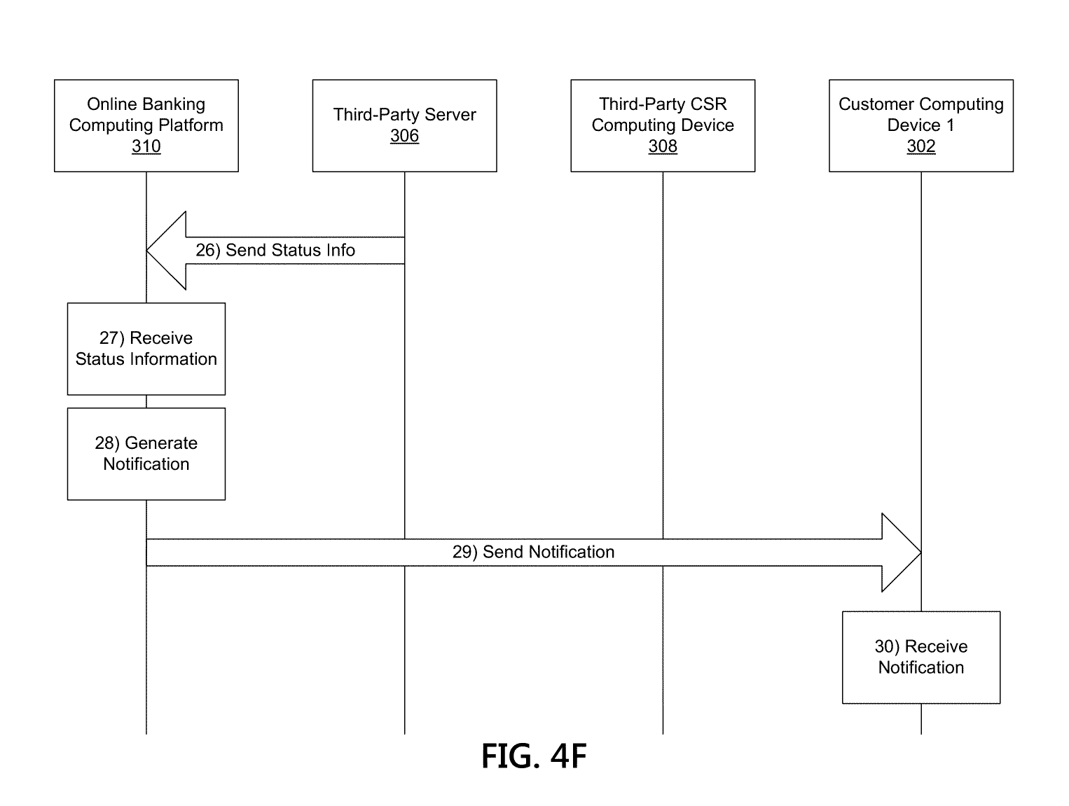

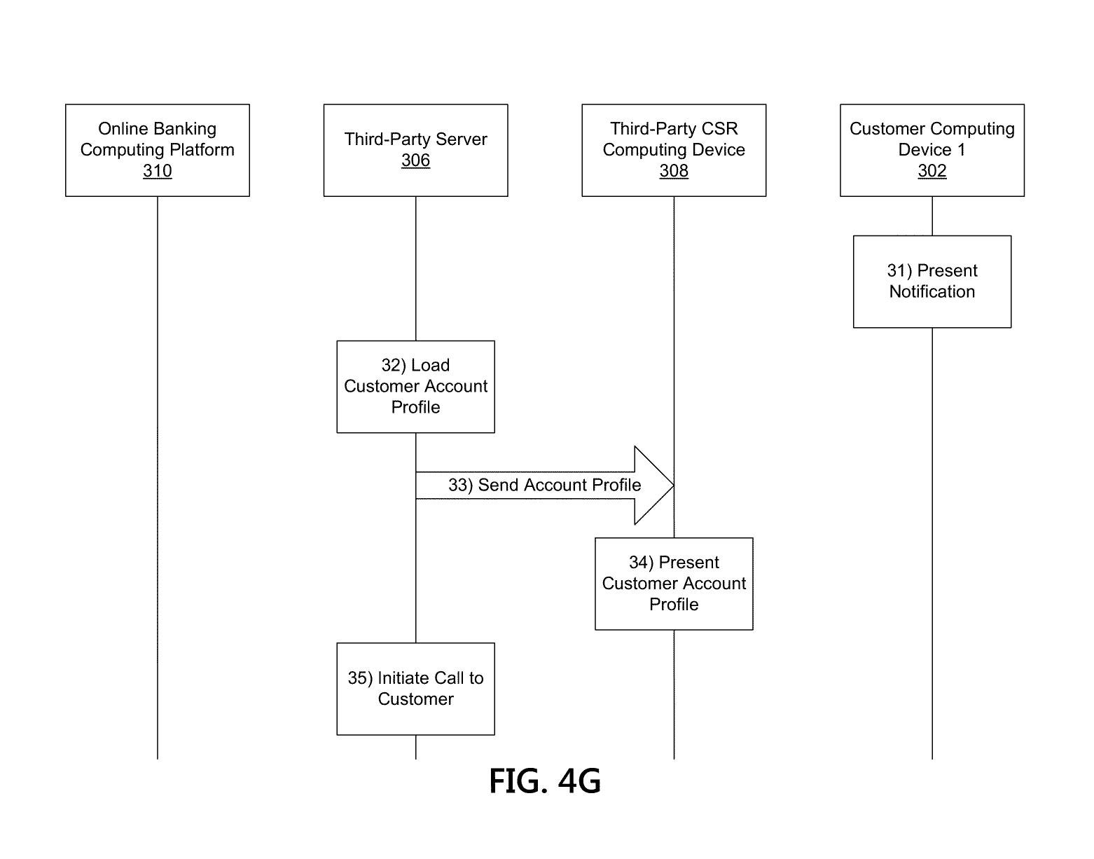

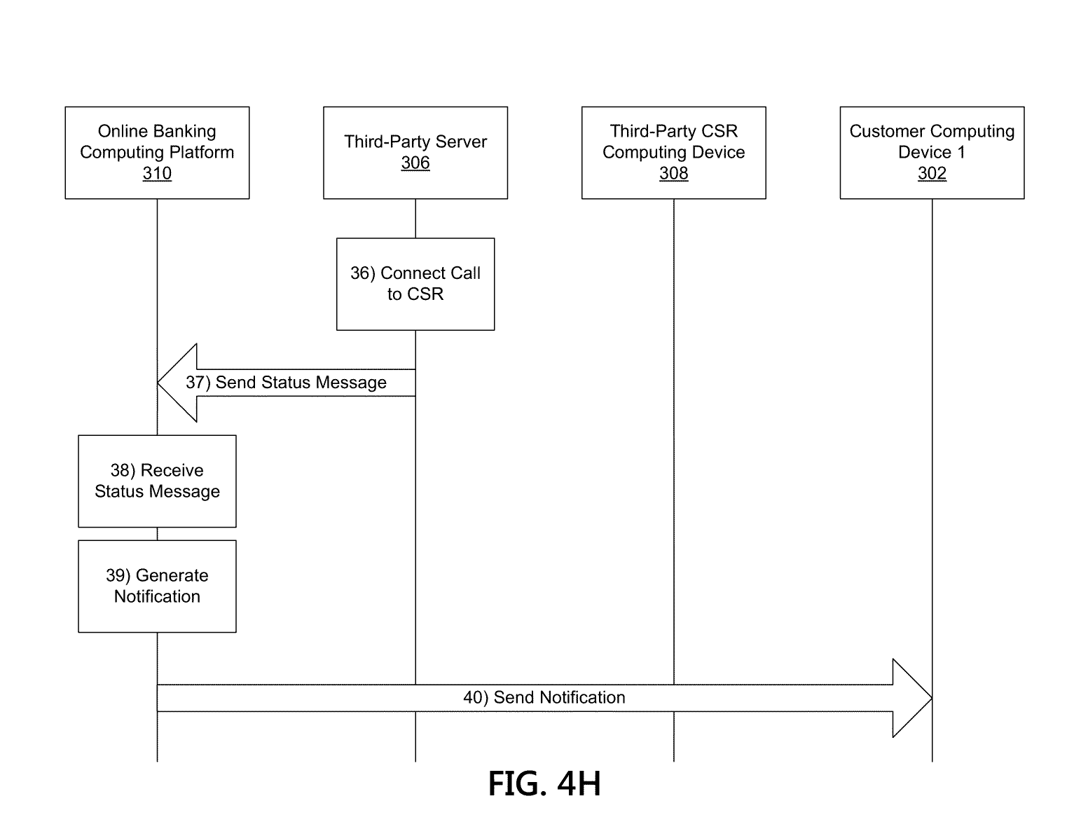

FIGS. 4A-4I depict an illustrative event sequence for providing enhanced online bill pay user interfaces in accordance with one or more example embodiments. Referring to FIG. 4A, at step 1, customer computing device 302 may receive a request to access an online banking portal. For example, at step 1, customer computing device 302 may receive input (e.g., from a user of customer computing device 302) requesting access to an online banking portal. The online banking portal may, for instance, be a graphical user interface and/or a collection of graphical user interfaces via which information associated with a financial institution may be presented, accessed, viewed, interacted with, provided, and/or otherwise used. For example, the online banking portal may be a graphical user interface and/or a collection of graphical user interfaces that provides information associated with a financial institution that owns, operates, controls, and/or otherwise implements online banking computing platform 310. In one or more arrangements, the online banking portal may, for example, be presented on and/or as a part of a website, webpage, portal, and/or other interface that may be electronically communicated and/or displayed to one or more users. Additionally or alternatively, the online banking portal may include information associated with one or more bank accounts and/or one or more user accounts that are maintained by and/or are otherwise associated with a financial institution (e.g., on behalf of the one or more users of the online banking portal).

At step 2, customer computing device 302 may send a request to access an online banking portal to online banking computing platform 310. For example, based on receiving the input requesting access to an online banking portal (e.g., at step 1), customer computing device 302 may, at step 2, send a request to access the online banking portal to online banking computing platform 310, which may, for instance, provide the online banking portal. At step 3, online banking computing platform 310 may receive the request to access the online banking portal from customer computing device 302.

At step 4, online banking computing platform 310 may authenticate the user of customer computing device 302. In authenticating the user of customer computing device 302, online banking computing platform 310 may, for example, generate and/or send one or more authentication prompts to customer computing device 302 that prompt the user of customer computing device 302 to enter and/or otherwise provide a username, password, one-time passcode, biometric input, and/or the like. In addition, online banking computing platform 310 may validate the input provided by the user of customer computing device 302 in response to such prompts. If online banking computing platform 310 determines that the input provided by the user of customer computing device 302 is valid, online banking computing platform 310 may authenticate the user of customer computing device 302 to an online banking portal provided by online banking computing platform 310. Alternatively, if online banking computing platform 310 determines that the input provided by the user of customer computing device 302 is invalid, online banking computing platform 310 may deny the user of customer computing device 302 access to the online banking portal and/or may prompt the user of customer computing device 302 to attempt to provide correct input in response to the one or more authentication prompts.

At step 5, online banking computing platform 310 may generate an online banking user interface. For example, after authenticating the user of customer computing device 302 (e.g., at step 4), online banking computing platform 310 may, at step 5, generate an online banking user interface. The online banking user interface may, for example, be and/or include one or more graphical user interfaces that make up and/or are otherwise associated with the online banking portal. For example, the online banking user interface may include information associated with a financial institution that owns, operates, controls and/or otherwise implements online banking computing platform 310 and/or information associated with one or more bank accounts and/or user accounts that are maintained by and/or otherwise associated with the financial institution.

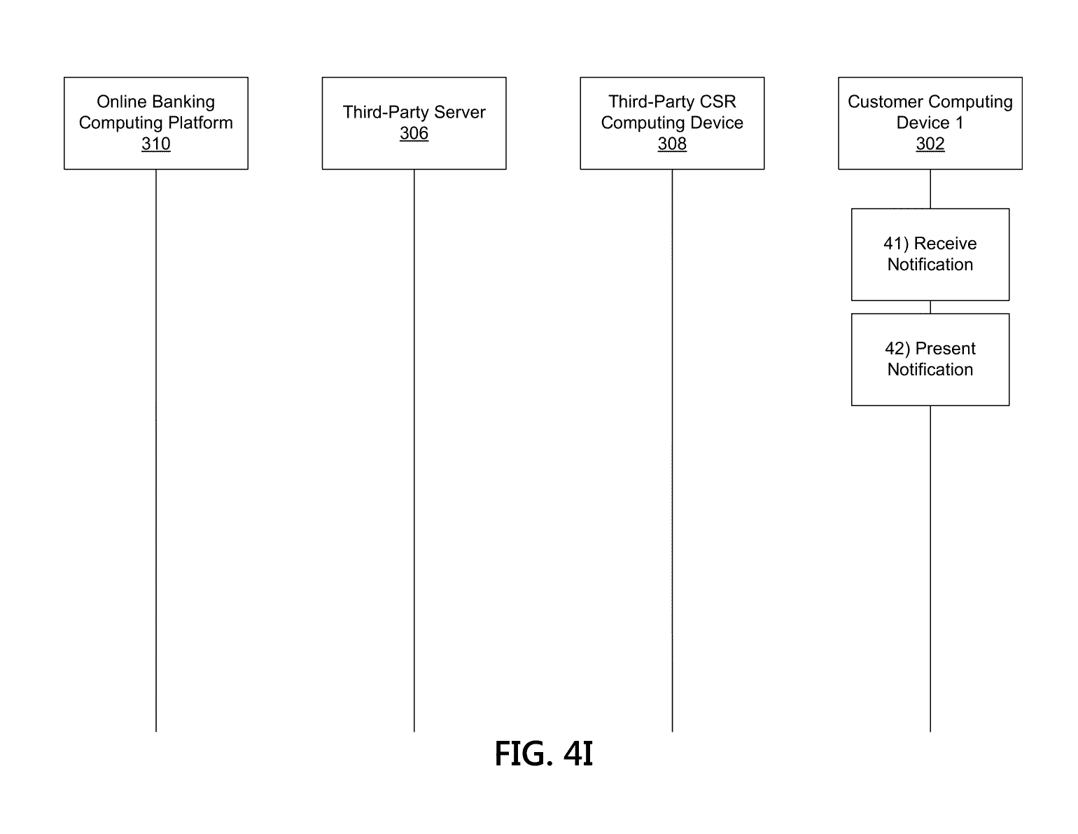

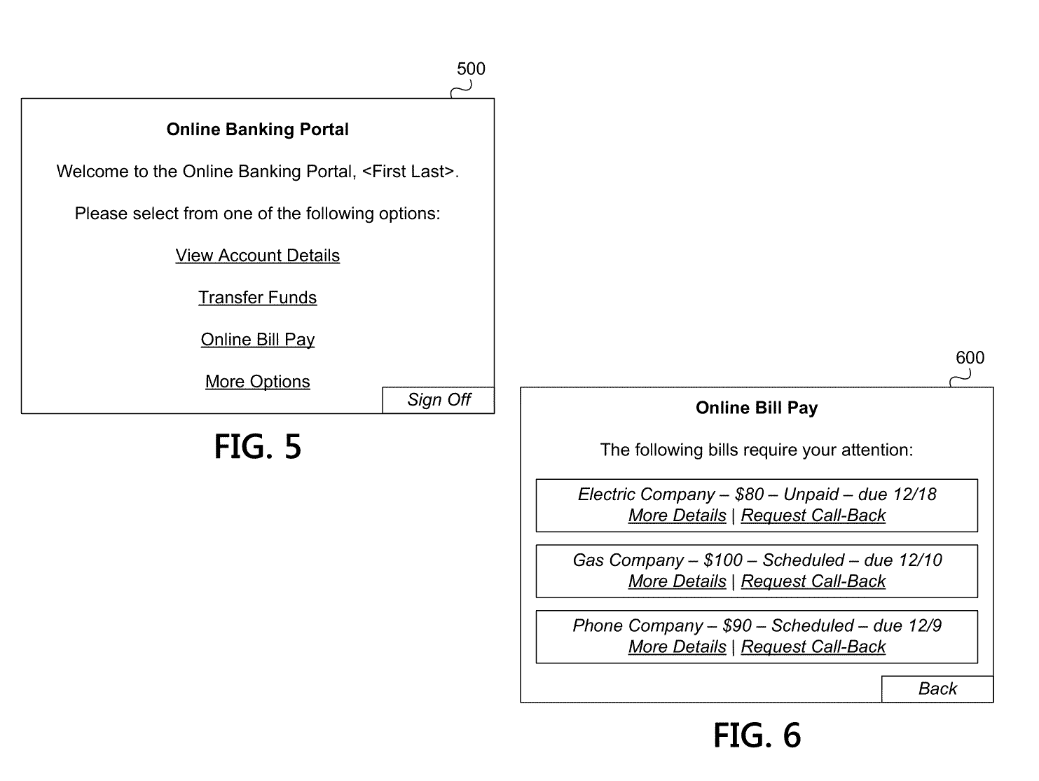

Referring to FIG. 4B, at step 6, online banking computing platform 310 may send the online banking user interface to customer computing device 302. At step 7, customer computing device 302 may receive the online banking user interface from online banking computing platform 310. At step 8, customer computing device 302 may present the online banking user interface. For example, in presenting the online banking user interface at step 8, customer computing device 302 may display, cause to be displayed, and/or otherwise present a graphical user interface that includes online banking content, such as a graphical user interface similar to graphical user interface 500, which is illustrated in FIG. 5. As seen in FIG. 5, graphical user interface 500 may include text and/or other information welcoming the user of customer computing device 302 to the online banking user interface and/or providing a menu that identifies and allows the user of customer computing device 302 to navigate to various functions that may be provided by online banking computing platform 310 via the online banking user interface. For example, graphical user interface 500 may include a “view account details” link that allows the user of customer computing device 302 to access one or more user interfaces view which account information may be presented, a “transfer funds” link that allows the user of customer computing device 302 to transfer funds between financial accounts, an “online bill pay” link that allows the user of customer computing device 302 to access an online bill pay user interface, and a “more options” link that allows the user of customer computing device 302 to access other user interfaces and/or functionalities that may be available via the online banking user interface.

Referring again to FIG. 4B, at step 9, customer computing device 302 may receive a request to access an online bill pay user interface. For example, at step 9, customer computing device 302 may receive input (e.g., from a user of customer computing device 302) requesting access to an online bill pay user interface. The online bill pay user interface may, for example, be a graphical user interface and/or a collection of graphical user interfaces, such as one or more webpages, that may be included in, accessible via, and/or provided as a part of the online banking user interface. In one or more arrangements, the online bill pay user interface may include information about one or more bills that have been issued for the user of customer computing device 302 and/or one or more controls allowing the user of customer computing device 302 to pay and/or otherwise manage the one or more bills. The one or more bills may, for instance, be issued by a financial institution operating online banking computing platform 310 and/or providing the online bill pay user interface (e.g., for credit cards, mortgages, lines of credit, and/or the like provided by the financial institution) and/or may be issued by one or more third-party entities different from the financial institution (e.g., electric companies, gas companies, phone companies, internet service providers, and/or the like). As discussed in greater detail below, the online bill pay user interface may, in one or more arrangements, include one or more call-back buttons. For example, the online bill pay user interface may include a call-back button for each bill identified in the online bill pay user interface, and each call-back button may allow a user interacting with the online bill pay user interface, such as the user of customer computing device 302, to request contact from the entity that issued the bill corresponding to the particular call-back button, even if the bill was issued by a third-party entity different from the financial institution that may be providing the online bill pay user interface.

At step 10, customer computing device 302 may send a request to access the online bill pay user interface to online banking computing platform 310. For example, based on receiving the input requesting access to the online bill pay user interface (e.g., at step 9), customer computing device 302 may, at step 10, send a request to access the online bill pay user interface to online banking computing platform 310, which may, for instance, provide the online bill pay user interface.

Referring to FIG. 4C, at step 11, online banking computing platform 310 may receive the request to access the online bill pay user interface from customer computing device 302. For example, at step 11, online banking computing platform 310 may receive, via communication interface 320, and from customer computing device 302, a request for an online bill pay page for a user of customer computing device 302.

At step 12, online banking computing platform 310 may generate an online bill pay user interface. For example, at step 12, online banking computing platform 310 may generate, based on the request for the online bill pay page, an online bill pay user interface for the user of customer computing device 302. In generating the online bill pay user interface for the user of customer computing device 302, online banking computing platform 310 may, for example, access and/or load bill pay data for the particular customer using customer computing device 302 from one or more bill pay databases. The bill pay data may, for example, identify particular bills that are outstanding for the particular customer using customer computing device 302 and/or other bills for the particular customer that may have been previously paid and/or are otherwise associated with the particular customer. The one or more bill pay databases may store and/or maintain this customer-specific bill pay data for one or more customers of the financial institution. In addition, such bill pay databases may, in some instances, be maintained and/or updated by online banking computing platform 310 and/or may store bill pay data that is created and/or modified based on billing information received from various third-party entities (e.g., for bills issued to customers of the financial institution by such third-party entities) and/or from other financial institution systems (e.g., for bills issued to customers of the financial institution by the financial institution itself in connection with various products and/or accounts).

At step 13, online banking computing platform 310 may send the online bill pay user interface to customer computing device 302. For example, after generating an online bill pay user interface for the user of customer computing device 302 (e.g., at step 12), online banking computing platform 310 may, at step 13, send, via communication interface 320, and to customer computing device 302, the online bill pay user interface. At step 14, customer computing device 302 may receive the online bill pay user interface from online banking computing platform 310. At step 15, customer computing device 302 may present the online bill pay user interface. For example, in presenting the online bill pay user interface at step 16, customer computing device 302 may display, cause to be displayed, and/or otherwise present a graphical user interface that includes online bill pay content, such as a graphical user interface similar to graphical user interface 600, which is illustrated in FIG. 6. As seen in FIG. 6, graphical user interface 600 may include text and/or other information identifying one or bills that may have been issued by the financial institution providing the online bill pay user interface and/or by one or more third-party entities for the user of customer computing device 302. For instance, in the example illustrated in FIG. 6, graphical user interface 600 includes a bill issued for the user of customer computing device 302 by an electric company, a bill issued for the user of customer computing device 302 by a gas company, and a bill issued for the user of customer computing device 302 by a phone company. Each bill may have a corresponding “more details” link, which the user of customer computing device 302 may be able to select to view more information about the corresponding bill, as well as a “request call-back” link, which the user of customer computing device 302 may be able to select to request a call back from and/or other contact with the entity that issued the corresponding bill (and which may, e.g., function as a call-back button, as discussed above).

Referring to FIG. 4D, at step 16, customer computing device 302 may receive a call-back request for a specific bill. For example, after presenting the online bill pay user interface (e.g., at step 15), customer computing device 302 may, at step 16, receive input (e.g., from a user of customer computing device 302) corresponding to a call-back request for a particular bill included in the online bill pay user interface. In some instances, such input may, for example, include and/or correspond to the user of customer computing device 302 selecting a call-back button included in the online bill pay user interface, such as one of the “request call-back” links included in graphical user interface 600.

At step 17, customer computing device 302 may send a call-back request to online banking computing platform 310. For example, based on receiving the input corresponding to a call-back request for a particular billed included in the online bill pay user interface (e.g., at step 16), customer computing device 302 may, at step 17, send a call-back request to online banking computing platform 310, which may receive and process the call-back request, as discussed in greater detail below.

At step 18, online banking computing platform 310 may receive the call-back request from customer computing device 302. For example, at step 18, online banking computing platform 310 may receive, via communication interface 320, and from customer computing device 302, a call-back request corresponding to a bill that was issued by a third-party entity and that is included in the online bill pay user interface. For instance, the call-back request (which may, e.g., be received by online banking computing platform 310 at step 18) may include information identifying a particular bill included in the online bill pay user interface for which the user of customer computing device 302 is requesting a call back and/or other contact. In addition, in one or more instances, the particular bill for which the user of customer computing device 302 is requesting a call back and/or other contact may be a bill that was issued by a third-party entity different from the financial institution (which may, e.g., operate online banking computing platform 310 and/or provide the online bill pay user interface). As illustrated in greater detail below, in one or more arrangements, online banking computing platform 310 may process the call-back request to connect the user of customer computing device 302 to a customer service representative of the third-party entity, even though the third-party entity is a different entity than the financial institution providing the online bill pay user interface.

Although several of the examples discussed here involve receiving and responding to a call-back request corresponding to a bill that issued by a third-party entity, in other instances, rather than receiving a call-back request corresponding to a bill that was issued by a third-party entity, online banking computing platform 310 may receive a call-back request corresponding to a bill that was issued by the financial institution (which may, e.g., operate online banking computing platform 310 and/or provide the online bill pay user interface). In these instances, online banking computing platform 310 may similarly process the call-back request so as to initiate a call to the user of customer computing device 302, and such a call may be connected to a customer service representative of the financial institution who may assist the user of customer computing device 302.

At step 19, online banking computing platform 310 may send a token to third-party server 306. For example, after receiving the call-back request corresponding to the bill that was issued by the third-party entity (e.g., at step 18), online banking computing platform 310 may, at step 19, send a token to third-party server 306. In sending a token to third-party server 306, online banking computing platform 310 may establish, via communication interface 320, a connection to a third-party server (e.g., third-party server 306) of the third-party entity that issued the bill included in the online bill pay user interface. The token may, for example, uniquely identify online banking computing platform 310 and/or hardware associated with online banking computing platform 310 and thus may enable third-party server 306 to verify the identity of online banking computing platform 310, conduct a handshake with online banking computing platform 310, and/or otherwise establish a secure connection with online banking computing platform 310.

At step 20, third-party server 306 may receive the token from online banking computing platform 310. Referring to FIG. 4E, at step 21, third-party server 306 may validate the token that was received from online banking computing platform 310. For example, at step 21, third-party server 306 may validate the token by matching information included in the token received from online banking computing platform 310 with one or more predefined, expected values for information included in the token that are stored by third-party server 306 to confirm identity of online banking computing platform 310. For instance, the token may include one or more security keys, measurements, and/or other information that may uniquely identify online banking computing platform 310 and/or hardware included in and/or otherwise associated with online banking computing platform 310. In addition, in one or more arrangements, validation of the token may enable third-party server 306 to carry over the authentication status of the user of customer computing device 302 from the online banking session involving customer computing device 302 and online banking computing platform 310 (e.g., in which the online banking user interface and/or the online bill pay user interface are provided to customer computing device 302 by online banking computing platform 310) to one or more new communication sessions involving the user of customer computing device 302 and one or more customer service representatives and/or devices of the third-party entity. As illustrated in greater detail below, by carrying over the authentication status of the user of customer computing device 302 in this way, the user of customer computing device 302 might not need to provide additional authentication credentials to the third-party entity in order to interact with a customer service representative of the third-party entity to discuss his or her account details, such as the one or more bills that the user of customer computing device 302 may have received via the online bill pay user interface.

At step 22, after validating the token, third-party server 306 may send a confirmation message to online banking computing platform 310. For example, after validating the token received from online banking computing platform 310 (e.g., at step 21), third-party server 306 may send a confirmation to online banking computing platform 310 indicating that the token was validated and/or including information that may enable online banking computing platform 310 to similarly verify the identity of third-party server 306 (e.g., so as to complete a handshake process and/or establish a secure connection between third-party server 306 and online banking computing platform 310). At step 23, online banking computing platform 310 may receive the confirmation message from third-party server 306. In addition, online banking computing platform 310 may, in some instances, verify information included in the confirmation message received from third-party server 306 so as to confirm the identity of third-party server 306 and/or establish a secure connection to third-party server 306.

At step 24, online banking computing platform 310 may send customer information to third-party server 306. For example, after receiving the confirmation message from third-party server 306 (e.g., at step 23), online banking computing platform 310 may, at step 24, send customer information to third-party server 306. In sending the customer information to third-party server 306, online banking computing platform 310 may cause third-party server 306 to initiate a call to the user of customer computing device 302. For example, the customer information (which online banking computing platform 310 may, e.g., send to third-party server 306 at step 24) may include information identifying a third-party account number, a bill number and/or other identifier corresponding to the bill for which the user of customer computing device 302 submitted the call-back request, customer contact information for the user of customer computing device 302, the name of the user of customer computing device 302, a callback phone number for the user of customer computing device 302, a preferred customer status indicator for the user of customer computing device 302, and/or other information. In addition, by providing this customer information and/or other information to third-party server 306, online banking computing platform 310 may facilitate the carrying over of the authentication level of the user of customer computing device 302, as online banking computing platform 310 may send one or more authentication flags to third-party server 306 indicating that the user of customer computing device 302 was authenticated based on a valid username, password, one-time passcode, biometric input, and/or the like (e.g., at step 4). Additionally or alternatively, in addition to sending the customer information to third-party server 306, online banking computing platform 310 also may send one or more commands instructing third-party server 306 to initiate a call to the customer using customer computing device 302 based on the customer information (which online banking computing platform 310 may, e.g., provide to third-party server 306).

In some embodiments, causing the third-party server to initiate the call to the user of the customer computing device may include sending customer information for the user of the customer computing device to the third-party server. For example, in causing third-party server 306 to initiate a call to the user of customer computing device 302, online banking computing platform 310 may send customer information for the user of customer computing device 302 to third-party server 306, as illustrated in the example discussed above. In addition, and as noted above, such customer information may include information identifying a third-party account number, a bill number and/or other identifier corresponding to the bill for which the user of customer computing device 302 submitted the call-back request, customer contact information for the user of customer computing device 302, the name of the user of customer computing device 302, a callback phone number for the user of customer computing device 302, a preferred customer status indicator for the user of customer computing device 302, and/or other information associated with the user of customer computing device 302 (which may, e.g., be loaded and/or determined by online banking computing platform 310 after authenticating the user of customer computing device 302 at step 4).

In some embodiments, the customer information may include an account number of the user of the customer computing device that is assigned to the user of the customer computing device by the third-party entity. For example, the customer information (which may, e.g., be sent by online banking computing platform 310 to third-party server 306 at step 24) may include an account number that was assigned to the user of customer computing device 302 by the third-party entity (which may, e.g., operate third-party server 306 and which issued the bill to the user of customer computing device 302 for which the user of customer computing device 302 has submitted a call-back request). This account number, which also may be referred to as a third-party account number, may be used by the third-party entity in issuing bills for and/or processing payments from the user of customer computing device 302. In addition, by providing the third-party account number to third-party server 306, online banking computing platform 310 may enable third-party server 306 to locate and/or identify records and/or account information for the user of customer computing device 302 that may be maintained internally by the third-party entity.

In some embodiments, the customer information may include a name of the user of the customer computing device and contact information for the user of the customer computing device. For example, the customer information (which may, e.g., be sent by online banking computing platform 310 to third-party server 306 at step 24) may include a name of the user of customer computing device 302 and/or contact information for the user of customer computing device 302, such as a phone number of the user of customer computing device 302, an email address of the user of customer computing device 302, and/or a call-back phone number for the user of customer computing device 302. By providing this information to third-party server 306, online banking computing platform 310 may enable a customer service representative of the third-party entity (who may, e.g., receive information from third-party server 306) to engage with and assist the user of customer computing device 302.

In some embodiments, the customer information for the user of the customer computing device may be presented to a customer service representative of the third-party entity. For example, the customer information (which may, e.g., be sent by online banking computing platform 310 to third-party server 306 at step 24) may be presented to a customer service representative of the third-party entity (who may, e.g., be using third-party customer service representative computing device 308, which may receive the customer information from third-party server 306), as illustrated in the examples discussed in greater detail below.

At step 25, third-party server 306 may receive the customer information from online banking computing platform 310. Referring to FIG. 4F, at step 26, third-party server 306 may send status information to online banking computing platform 310. For example, at step 26, third-party server 306 may send, to online banking computing platform 310, status information indicating a current call volume at one or more call centers operated by and/or otherwise associated with the third-party entity and/or an expected wait time for the user of customer computing device 302 to receive a call back from the third-party entity and/or another communication from the third-party entity responsive to the call-back request submitted by the user of customer computing device 302. As illustrated below, this status information may be used by online banking computing platform 310 to inform the user of customer computing device 302 of the current call volume and/or the expected wait time.

At step 27, online banking computing platform 310 may receive the status information from third-party server 306. At step 28, online banking computing platform 310 may generate a notification. For example, at step 28, online banking computing platform 310 may generate a notification based on the status information received from third-party server 306, and such a notification may indicate that the call-back request has been submitted to the third-party entity and/or may indicate an expected wait time for the customer using customer computing device 302 to receive a call-back communication from the third-party entity operating third-party server 306. For instance, after causing third-party server 306 to initiate the call to the user of customer computing device 302, online banking computing platform 310 may generate a notification indicating that the call-back request has been submitted to the third-party entity.

At step 29, online banking computing platform 310 may send the notification to customer computing device 302. For example, at step 29, online banking computing platform 310 may send, via communication interface 320, and to customer computing device 302, the notification indicating that the call-back request has been submitted to the third-party entity.

In some embodiments, the notification indicating that the call-back request has been submitted to the third-party entity may include information indicating an expected call-back time determined based on current call volume information. For example, the notification indicating that the call-back request has been submitted to the third-party entity (which may, e.g., be generated by online banking computing platform 310 at step 28 and/or sent to customer computing device 302 at step 29) may include information indicating an expected call-back time determined based on current call volume information, as discussed above. In some instances, the expected call-back time may be determined by third-party server 306 based on the current call volume information, and third-party server 306 may calculate the expected call-back time based on the number of calls in a queue prior to the call-back request from the user of customer computing device 302, the number of customer service representatives currently working and/or available, and/or the average call length. In other instances, the expected call-back time may be determined by online banking computing platform 310 based on the current call volume information, and online banking computing platform 310 may calculate the expected call-back time based on historical data for call-back communications that may be accessed, stored, and/or maintained by online banking computing platform 310.

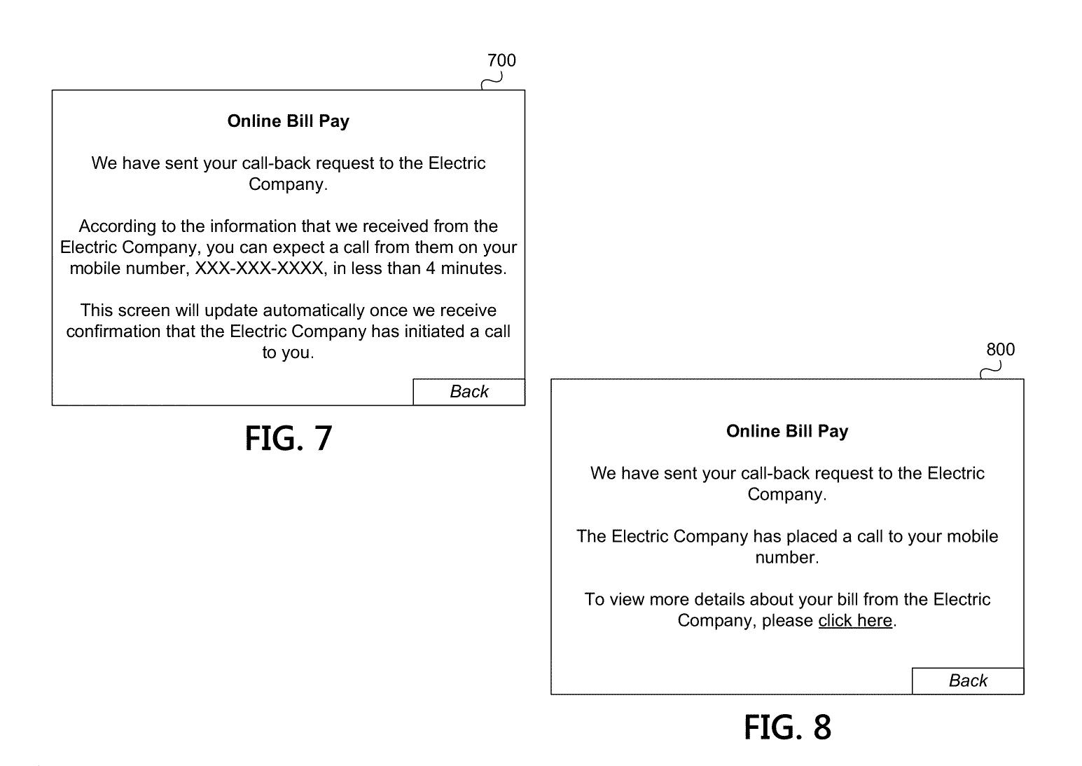

At step 30, customer computing device 302 may receive the notification from online banking computing platform 310. For example, at step 30, customer computing device 302 may receive the notification from online banking computing platform 310 indicating that the call-back request has been submitted to the third-party entity. Referring to FIG. 4G, at step 31, customer computing device 302 may present the notification received from online banking computing platform 310. For example, in presenting the notification, customer computing device 302 may display, cause to be displayed, and/or otherwise present a graphical user interface that includes notification content, such as a graphical user interface similar to graphical user interface 700, which is illustrated in FIG. 7. As seen in FIG. 7, graphical user interface 700 may include text and/or other information indicating that the call-back request has been submitted by the financial institution to the third party entity (e.g., the electric company in the illustrated example), information indicating an expected call-back time (which may, e.g., be determined based on current call volume information, as discussed above), and/or information indicating that user interface will be updated once a call has been initiated by the third-party entity to the user of customer computing device 302.

Referring again to FIG. 4G, at step 32, third-party server 306 may load customer account profile data. For example, at step 32, third-party server 306 may load customer account profile data associated with the user of customer computing device 302. Such customer account profile data may, for instance, include customer contact information for the user of customer computing device 302, the name of the user of customer computing device 302, a callback phone number for the user of customer computing device 302, a preferred customer status indicator for the user of customer computing device 302, and/or other information associated with the user of customer computing device 302.

At step 33, third-party server 306 may send the customer account profile data to third-party customer service representative computing device 308. At step 34, third-party customer service representative computing device 308 may present the customer account profile data received from third-party server 306. For example, in presenting the customer account profile data, third-party customer service representative computing device 308 may display, cause to be displayed, and/or otherwise present one or more graphical user interfaces (e.g., to a customer service representative of the third party entity), and the one or more graphical user interfaces may include all or a portion of the customer account profile data.

At step 35, third-party server 306 may initiate a call to the customer using customer computing device 302. For example, at step 35, third-party server 306 may initiate a call to the customer using customer computing device 302 by opening a new telephone connection and dialing a phone number associated with the user of customer computing device 302 (e.g., based on the contact information and/or a call-back number provided to third-party server 306 by online banking computing platform 310). Referring to FIG. 4H, at step 36, third-party server 306 may connect the call to a customer service representative. For example, at step 36, third-party server 306 may connect the call to the customer service representative who may be using third-party customer service representative computing device 308.

At step 37, third-party server 306 may send a status message to online banking computing platform 310. For example, after initiating a call to the customer using customer computing device 302 and/or connecting the call to a customer service representative, third-party server 306 may send, to online banking computing platform 310, a status message indicating that a call has been placed to the user of customer computing device 302. At step 38, online banking computing platform 310 may receive the status message from third-party server 306. At step 39, online banking computing platform 310 may generate a notification based on the status message received from third-party server 306. For example, at step 39, online banking computing platform 310 may generate a notification indicating that a call has been placed to the user of customer computing device 302, based on information included in the status message received from third-party server 306 at step 38. At step 40, online banking computing platform 310 may send the notification to customer computing device 302.

Referring to FIG. 4I, at step 41, customer computing device 302 may receive the notification from online banking computing platform 310. For example, at step 41, customer computing device 302 may receive the notification from online banking computing platform 310 indicating that a call has been placed to the user of customer computing device 302. At step 41, customer computing device 302 may present the notification. For example, in presenting the notification, customer computing device 302 may display, cause to be displayed, and/or otherwise present a graphical user interface that includes notification content, such as a graphical user interface similar to graphical user interface 800, which is illustrated in FIG. 8. As seen in FIG. 8, graphical user interface 800 may include text and/or other information indicating that a call has been initiated to the user of customer computing device 302 and/or one or more controls that allow the user of customer computing device 302 to access and/or view details about the bill for which the user of customer computing device 302 submitted the call-back request.

In some embodiments, online banking computing platform 310 may be configured to present at least one notification generated by the third-party entity in the online bill pay user interface. For example, in some instances, online banking computing platform 310 may be configured to present a notification to all customers of the third-party entity in the online bill pay user interface, and such a notification may include content that is generated by and/or otherwise created by the third-party entity. In other instances, online banking computing platform 310 may be configured to present such a notification to selected customers of the third-party entity in the online bill pay user interface, and the recipient customers of such a notification may, for instance, be selected based on account information registered with the financial institution. For example, such a notification (which may, e.g., include content that is generated by and/or otherwise created by the third-party entity) may be presented to selected customers of the third-party entity who reside in particular cities and/or states and/or otherwise have certain characteristics that may be specified by the third-party entity.

In addition, in some additional and/or alternative embodiments, instead of and/or in addition to initiating a telephone call to provide a call-back communication, the third-party entity may provide other responsive communications to a customer of the financial institution. For example, a third-party customer service representative could respond to a call-back request (which may, e.g., be submitted by a customer of the financial institution, as in several examples discussed above) using an email communication, a chat communication, a push notification, and/or the like.

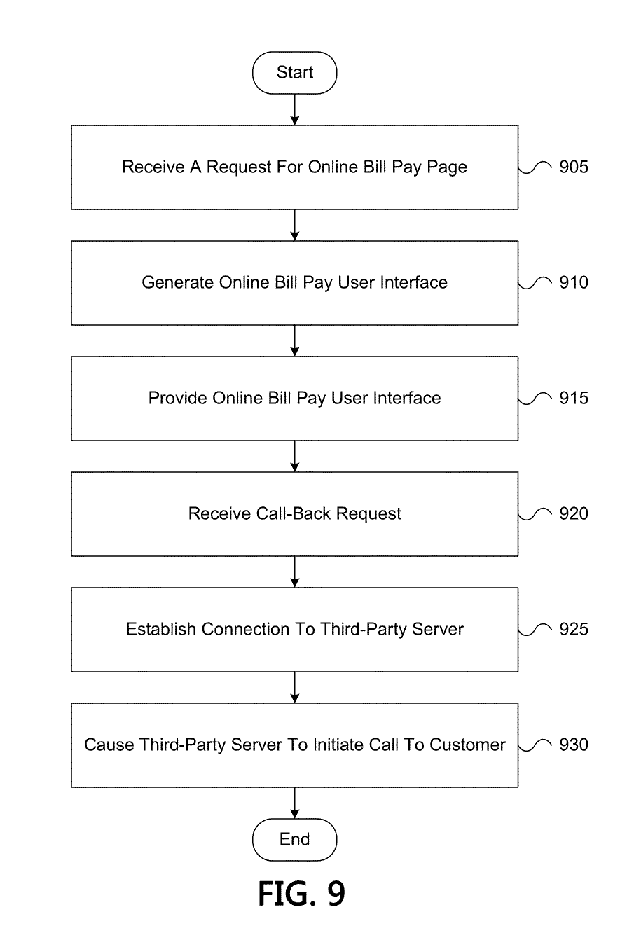

FIG. 9 depicts an illustrative method for providing enhanced online bill pay user interfaces in accordance with one or more example embodiments. Referring to FIG. 9, at step 905, a computing platform may receive a request for an online bill pay page. At step 910, the computing platform may generate an online bill pay user interface. At step 915, the computing platform may provide the online bill pay user interface (e.g., by sending the online bill pay user interface to another computing device, such as a customer computing device). At step 920, the computing platform may receive a call-back request (which may, e.g., be associated with a particular bill included in the online bill pay user interface). At step 925, the computing platform may establish a connection to a third-party server (which may, e.g., be associated with a third-party entity that issued the bill for which the call-back request was received). At step 930, the computing platform may cause the third-party server to initiate a call to a customer (who may, e.g., be using the computing device to which the online bill pay user interface was provided and/or from which the call-back request was received).

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may comprise one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A system, comprising:
at least one processor;
a communication interface communicatively coupled to the at least one processor; and
memory storing computer-readable instructions that, when executed by the at least one processor, cause the system to:
receive, via the communication interface, and from a customer computing device, a request for an online bill pay page for a user of the customer computing device;
generate, based on the request for the online bill pay page, an online bill pay user interface for the user of the customer computing device;
send, via the communication interface, and to the customer computing device, the online bill pay user interface;
receive, via the communication interface, and from the customer computing device, a call-back request corresponding to a bill that was issued by a third-party entity and that is included in the online bill pay user interface;
establish, via the communication interface, a connection to a third-party server of the third-party entity that issued the bill included in the online bill pay user interface; and
cause the third-party server to initiate a call to the user of the customer computing device.

2. The system of claim 1, wherein causing the third-party server to initiate the call to the user of the customer computing device includes sending customer information for the user of the customer computing device to the third-party server.

3. The system of claim 2, wherein the customer information includes an account number of the user of the customer computing device that is assigned to the user of the customer computing device by the third-party entity.

4. The system of claim 2, wherein the customer information includes a name of the user of the customer computing device and contact information for the user of the customer computing device.

5. The system of claim 2, wherein the customer information for the user of the customer computing device is presented to a customer service representative of the third-party entity.

6. The system of claim 1, wherein the memory stores additional computer-readable instructions that, when executed by the at least one processor, cause the system to:
after causing the third-party server to initiate the call to the user of the customer computing device, generate a notification indicating that the call-back request has been submitted to the third-party entity; and
send, via the communication interface, and to the customer computing device, the notification indicating that the call-back request has been submitted to the third-party entity.

7. The system of claim 6, wherein the notification indicating that the call-back request has been submitted to the third-party entity includes information indicating an expected call-back time determined based on current call volume information.

8. The system of claim 1, wherein the system is configured to present at least one notification generated by the third-party entity in the online bill pay user interface.

9. A method, comprising:
at a computing platform comprising at least one processor, memory, and a communication interface:
receiving, by the at least one processor, via the communication interface, and from a customer computing device, a request for an online bill pay page for a user of the customer computing device;
generating, by the at least one processor, based on the request for the online bill pay page, an online bill pay user interface for the user of the customer computing device;
sending, by the at least one processor, via the communication interface, and to the customer computing device, the online bill pay user interface;
receiving, by the at least one processor, via the communication interface, and from the customer computing device, a call-back request corresponding to a bill that was issued by a third-party entity and that is included in the online bill pay user interface;
establishing, by the at least one processor, via the communication interface, a connection to a third-party server of the third-party entity that issued the bill included in the online bill pay user interface; and
causing, by the at least one processor, the third-party server to initiate a call to the user of the customer computing device.

10. The method of claim 9, wherein causing the third-party server to initiate the call to the user of the customer computing device includes sending customer information for the user of the customer computing device to the third-party server.

11. The method of claim 10, wherein the customer information includes an account number of the user of the customer computing device that is assigned to the user of the customer computing device by the third-party entity.

12. The method of claim 10, wherein the customer information includes a name of the user of the customer computing device and contact information for the user of the customer computing device.

13. The method of claim 10, wherein the customer information for the user of the customer computing device is presented to a customer service representative of the third-party entity.

14. The method of claim 9, further comprising:
after causing the third-party server to initiate the call to the user of the customer computing device, generating, by the at least one processor, a notification indicating that the call-back request has been submitted to the third-party entity; and
sending, by the at least one processor, via the communication interface, and to the customer computing device, the notification indicating that the call-back request has been submitted to the third-party entity.

15. The method of claim 14, wherein the notification indicating that the call-back request has been submitted to the third-party entity includes information indicating an expected call-back time determined based on current call volume information.

16. The method of claim 9, wherein the computing platform is configured to present at least one notification generated by the third-party entity in the online bill pay user interface.

17. One or more non-transitory computer-readable media storing instructions that, when executed by a computing platform comprising at least one processor, memory, and a communication interface, cause the computing platform to:
receive, via the communication interface, and from a customer computing device, a request for an online bill pay page for a user of the customer computing device;
generate, based on the request for the online bill pay page, an online bill pay user interface for the user of the customer computing device;
send, via the communication interface, and to the customer computing device, the online bill pay user interface;
receive, via the communication interface, and from the customer computing device, a call-back request corresponding to a bill that was issued by a third-party entity and that is included in the online bill pay user interface;
establish, via the communication interface, a connection to a third-party server of the third-party entity that issued the bill included in the online bill pay user interface; and
cause the third-party server to initiate a call to the user of the customer computing device.

18. The one or more non-transitory computer-readable media of claim 17, wherein causing the third-party server to initiate the call to the user of the customer computing device includes sending customer information for the user of the customer computing device to the third-party server.

19. The one or more non-transitory computer-readable media of claim 18, wherein the customer information includes an account number of the user of the customer computing device that is assigned to the user of the customer computing device by the third-party entity.

20. The one or more non-transitory computer-readable media of claim 18, wherein the customer information includes a name of the user of the customer computing device and contact information for the user of the customer computing device.
